(19) United States
(12) Patent Application Publication
(10) Pub. No.: US 2015/0033103 A1
(43) Pub. Date: Jan. 29, 2015

(54) CUSTOMIZED NEWSLETTER CREATION AND DELIVERY

(71) Applicant: LIVELY, INC., SAN FRANCISCO, CA (US)

(72) Inventors: David Glickman, SAN FRANCISCO, CA (US); Ignacio Fanlo, MILL VALLEY, CA (US); Alexis Longinotti, MOUNTAIN VIEW, CA (US); Keith Dutton, SANTA BARBARA, CA (US)

(21) Appl. No.: 14/334,648

(22) Filed: Jul. 17, 2014

Related U.S. Application Data
(60) Provisional application No. 61/857,673, filed on Jul. 23, 2013.

(51) Int. Cl. G06F 17/21

(52) U.S. Cl. CPC G06F 17/212
USPC 715/202

(57) ABSTRACT

A computer-implemented system is constructed and adapted to: associate at least one user with a subscriber to a system; obtain and store at least one content contribution from said at least one user; determine relevant content from said at least one content contribution; determine a booklet layout for said relevant content; and produce said booklet with said relevant content based on booklet layout.

### RELATED APPLICATION

This application is related to and claims priority from co-pending and co-owned U.S. Application No. 61/857,673, filed Jul. 23, 2013, titled “Customized Newsletter Creation and Delivery,” the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### BACKGROUND OF THE INVENTION

1. Field of the Invention

This invention relates to a customized newsletters, and, more particularly, to creation and delivery of customized newsletters.

2. Background and Overview

Many people, especially the elderly, live alone or away from their families. While technology, e.g., the Internet, now provides numerous ways for people to stay in touch with each other, technological requirements (e.g., competency requirements) often preclude certain groups from benefiting from such technology.

Certain groups of people, in particular the elderly, often become isolated and out of touch with their peers and relatives. While younger relatives may be connected to each other through social networks (e.g., Facebook, Twitter, LinkedIn, etc.) and the like, older people who have not adopted new technologies may become even more isolated. Users of social networks and other such technologies tend to share personal information with each other at rates heretofore unseen. The same time, they share very little of this information with their older relatives (e.g., grandparents).

There are other groups of users who are sometimes (periodically) technologically isolated. For example, children who attend summer camp are often intentionally kept away from computer-related technology. At the same time, however, these children may wish to receive updated personal information from their parents and siblings. While historically these updates took the form of written letters, more recently summer camps will collect and consolidate emails from parents and provide these to the campers.

It is desirable to provide a way for people to communicate information via hybrid technologies, so that groups of people who have not yet adopted (and may never adopt) new technologies do not become socially isolated. It is also desirable to provide a way for a person's extended group (e.g., their children, grandchildren, etc.) to provide regular updates about their lives.

### BRIEF DESCRIPTION OF THE DRAWINGS

Other objects, features, and characteristics of the present invention as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 shows an overview of a newsletter production and distribution framework in accordance with embodiments hereof;

FIG. 2 shows details of user/subscriber data;

FIG. 3 is a flowchart of operation of the system/framework of FIG. 1;

FIG. 4 is a flowchart depicting a relevancy selection algorithm according to embodiments hereof;

FIGS. 5A and 5B show exemplary booklet layouts;

FIGS. 6A to 6N show exemplary panel layouts for images and associated captions;

FIGS. 7A and 7B shown example booklets produced in accordance with an embodiment of the system; and

FIGS. 8A to 8C depict aspects of computing and computer devices in accordance with embodiments.

### DETAILED DESCRIPTION OF THE PRESENTLY PREFERRED EXEMPLARY EMBODIMENTS

### Glossary and Abbreviations

As used herein, unless used otherwise, the following terms or abbreviations have the following meanings:

FIFO means first in first out;

GUI means graphical user interface (UI);

LIFO means last in first out;

PPI means pixels per inch; and

UI means user interface.

### Background and Overview

Overview—Structure

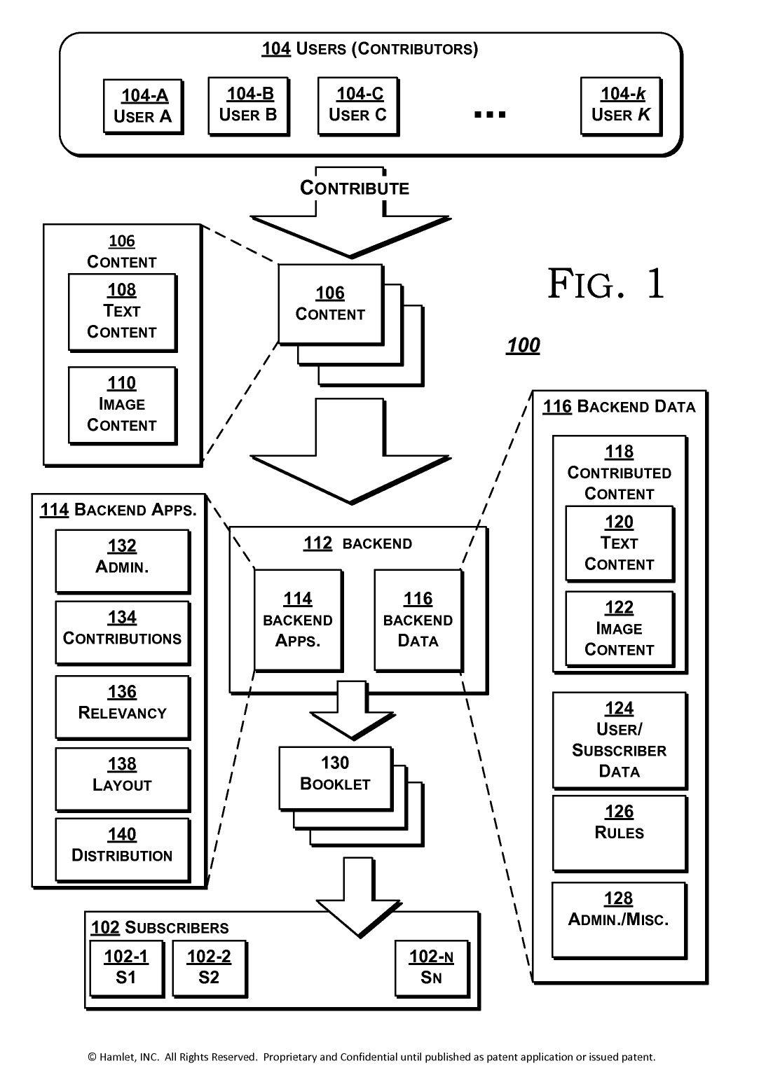

FIG. 1 shows an overview of an exemplary newsletter production and distribution framework 100 for a system. The framework 100 has multiple subscribers 102. Each subscriber 102 has one or more users 104 associated therewith. It should be appreciated that a particular user may be associated with more than one subscriber. In addition, it should be appreciated that a subscriber may also be a user.

Users 104 may contribute content 106 to be distributed or provided selectively to subscribers 102. More specifically, a particular user may contribute content 106 to be distributed or provided selectively to a subscriber with which that particular user is associated.

The content 106 may comprise text content 108 and/or image content 110. The text content 108 may be a text message or letter or the like. The image content may be a photograph or any other image that may be provided in digital form. Preferably image content also includes a caption in text form.

Users provide their contributions to a backend 112. The backend 112 comprises backend applications 114 and backend data 116.

The backend data 116 may include user-contributed content 118 that includes user-contributed text content 120 and/or user-contributed image content 122. The backend data 116 may also include user/subscriber data 124, rules 126, and other administrative and miscellaneous data 128.

The backend applications 114 may include administrative applications 132, contributions applications 134, relevancy determination applications 136, layout applications 138, and distribution applications 140.

The backend applications 114 use the backend data to obtain contributions from users 104, and to use those contributions to produce booklets 130 that may be provided to appropriate subscribers 102.

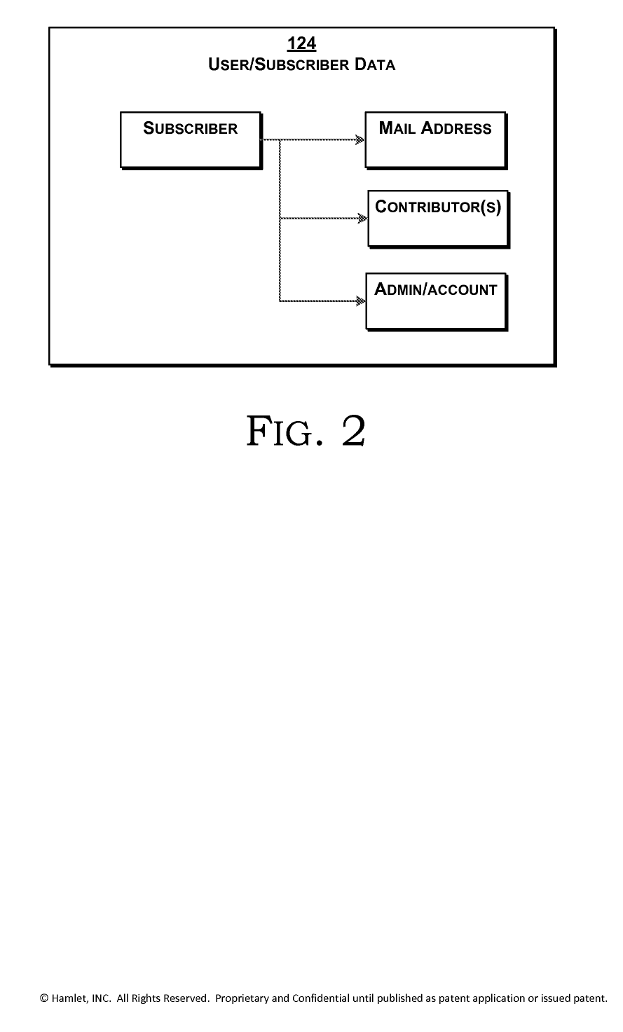

The user/subscriber data 124 preferably includes a mapping from each subscriber 102 to data associated with that subscriber. With reference to FIG. 2, each subscriber 102 may have associated therewith a mail address (preferably an address at which the subscriber can receive regular/paper mail), a list of one or more contributors (comprising a list of users 104 who may contribute content to that subscriber), and other administrative and account information. The list of users associated each subscriber is sometimes referred to herein as that subscribers “circle.”

Operation of the system 100 with respect to a particular subscriber 102 is described with reference to the flow chart 300 in FIG. 3. Various components off the flowchart 300 are shown disconnected in the drawing indicating that they either occur in parallel or at times.

First, the subscriber registers with the system (at S301, e.g., using administrative application(s) 132). Having registered, users in that subscriber's circle may make contributions for/on behalf of that subscriber (at 5301, e.g., using contributions application(s) 134). As shown in the drawing, the user contributions may be made at any time and may be made repeatedly. The administrative application(s) 132 preferably provide a GUI to support registration and other administrative features.

At various intervals, preferably regular intervals, this system determines relevant content for the next booklet for the subscriber (at 5303, e.g., using relevancy application(s) 136). The system then determines a layout for the next booklet (at 5304, e.g., using layout application(s) 138), and then produces the booklet and distributes it to the subscriber (at 5305, e.g., using distribution application(s) 140).

In operation, subscribers 102 register with the system, e.g., using the administrative applications 132 (S301). Each subscriber 102 forms a circle of users 104. Users are preferably added to a subscriber's circle when the subscriber registers with the system, however a subscriber may add (or remove) users from their circle at any time during or after registration. The system may obtain information from the subscriber about each user's relationship with that subscriber. For example, the system may obtain information from the subscriber about family relationships between the subscriber and the users in the subscriber's circle.

The backend 112 collects content from users 104 (using contributions application(s) 134) and selectively and regularly compiles that content into booklets 130 (using relevancy and layout applications 136, 138) which may be sent (using distribution application(s) 140) to the appropriate subscribers 102 at the appropriate mail address (e.g., the mail address associated with the subscriber in the user/subscriber data 124). Even though each user may be associated with more than one subscriber, it should be appreciated that user content that is contributed to the system is associated with a particular subscriber, and that content should only be provided to that subscriber. The contributions application(s) 134 preferably provide a GUI, e.g., via a web-based application and/or a device application to support contribution of content by users.

As will be explained in greater detail below, the backend applications 114 (specifically layout application(s) 138) may choose a layout for the booklet 130 based, for example, on the amount and type of content that has been provided for a subscriber.

As used herein, the term “booklet” refers to any document comprising one or more pages. Exemplary booklet layouts are described below. It should be appreciated, however, that the system is not limited in any way by the example layouts shown or by the content of the booklets.

Registration

Each subscriber 102 is preferably registered with the system 100. The system is not limited by the particular manner of registration. However, the system preferably obtains and maintains for each subscriber at least a subscriber mail address (see FIG. 2), and a list of one or more users 104 that may contribute content to that subscriber. The list of users may be specified, e.g., by a list of names and corresponding e-mail addresses. The backend 112 preferably uses the user information (e.g. the user's e-mail address) to verify that the particular user is authorized to contribute content to the subscriber. In this description the list of users 104 that may contribute content to a particular subscriber may be referred to as that subscribers “circle,” or “circle members.”

Preferably the subscriber provides the names and e-mail addresses of their circle members during registration, and the sends invitations to each of the contributors, inviting them to contribute content to the subscriber.

A subscriber may add or remove users from their circle at any time after registration.

In some embodiments a subscriber may provide circle members with system access, thereby allowing those members to add or invite additional contributors for that subscriber.

User Contributions

Users 104 may contribute content to any subscriber with whom they are associated. That is, a user may contribute content to any subscriber that has listed that user has a contributor, thereby putting that user into that subscriber's circle.

Users may contribute content at any time. The content may be uploaded to the backend, for example via a web interface or a specific application. Text content 108 may be typed directly into a web interface, or it may be uploaded by file. Image content is preferably uploaded via a web interface.

The backend 112 stores uploaded content as contributed content 118, with each content item being associated with the contributing user and a subscriber. Preferably the backend 112 maintains information about the time and date at which each contribution is made.

The backend applications 114 preferably apply content upload rules to ensure that contributed content meets sufficient requirements for inclusion in a booklet.

For text content (messages) 108, the system may impose a length limit (e.g., 300 characters), and preferably automatically rejects messages that exceed the character limit. The contributing user is preferably advised when a message exceeds the character limit and has been rejected. It should be appreciated that the system is not to be limited in any way I any particular length limit imposed.

For image content (photos) 110, the system may impose size and or image quality limits. In preferred implementations, image quality may be measured in terms of pixel counts or densities. It is desirable that the reject images that will not reproduce well in a booklet. Preferably these images are rejected at the time of upload so that the contributing user has an opportunity to provide an alternative image. In some cases, a contributing user may be advised by e-mail of a rejected image. In presently preferred implementations, images having a density of 250-300 PPI (pixels-per-inch) at 100% size were considered acceptable. Those of ordinary skill in the art will appreciate and understand, upon reading this description, that acceptable image quality limits may vary and are not intended to impose any limits on the scope of the system.

Booklet Compilation

Booklet compilation for a particular subscriber takes place routinely (e.g., every 2 weeks). A booklet for a subscriber is compiled from content that has been contributed to that subscriber by users in that subscriber's circle. If there is insufficient contributed content, filler material may be used (as described below).

The process of compiling a booklet for a subscriber may be considered two phases. In the first phase, the backend 112 determines relevant content to be included in the next booklet for that subscriber (S303 in FIG. 3). The relevant content is determined (as described in greater detail below) using contributed content 118 for that subscriber and various rules 126. Once relevant content for a particular booklet has been determined, a second phase determines the layout of the relevant content in the booklet (S304 in FIG. 3). Preferably the determination of relevant content in the first phase is made close in time to the determination of the booklet layout, so that the current booklet may contain the most recent user contributions. However, in some implementations, some older the material may be used in addition to recent contributions.

While the backend 112 is shown as one block in the diagram in FIG. 1, it should be appreciated that the various functions performed by the backend may be performed, at least in part, by distinct and separate entities. For example, the selection of relevant content in the first phase may be performed by one entity, whereas the layout and subsequent printing of the booklets in the second phase may be performed by a different entity entirely. The various entities and/or components may be co-located or may be located apart from each other. Thus, the various that canned applications 114 may be located at different/distinct entities.

In some cases, it may be preferable to have multiple entities performing the printing and distribution aspects, so that these may be done closer to the subscribers. Such a system may reduce distribution costs.

Determining Relevant Content

An exemplary approach to determination of relevant content from the contributed content is described here. This approach is provided by way of example and is not intended to be in any way limiting. This approach applies a set of panel-agnostic rules in the selection of relevant content. As such, the selection is independent of the manner in which panels will be selected and content will be placed in the next phase.

As used herein, a “content unit” is an item of content that will be used in a booklet. A content unit may be a message (text content 108) or a photo (image content 110). The relevancy determination uses a particular number of content units for each booklet. That is, the relevancy determination attempts to find a particular number of content units from the contributed content that can be used in each booklet. If insufficient content units are available, filler content (e.g., crosswords, Sudoku, and the like) may be used. In a presently preferred implementation the relevancy determination attempts to find twelve (12) content units for each booklet.

For the purposes of this description, content for a particular subscriber is described as being stored in lists or buckets, with distinct lists/buckets for messages, photos, and filler. Within each bucket of contributed content, the contributed content is stored along with the identity of the circle member who contributed that content and submission date of the content.

There are preferably multiple buckets of filler content, each having a different type of content (e.g., crosswords, Sudoku, etc.) For the purposes of subsequent layout (in the next phase) a content unit of filler content is considered to be an image. The caption of a filler content image may be related to the content or it may be a message to the subscriber (e.g., “Get your family to share more.”).

Every time the system selects content from a bucket (a circle member, or a filler content type), the system needs to mark that content as used, so as not use it again.

The relevancy selection repeatedly chooses messages and photos until either it has reached the required number of content units for the booklet or it runs out of contributed content.

The selection of relevant content first attempts to choose some messages (as opposed to pictures) from contributions of circle members. This is done to avoid having a booklet consisting entirely of pictures. Having selected some messages (if any exist) the system then tries to select some pictures (if any exist). This process of selecting messages and pictures is repeated until either it has reached the required number of content units for the booklet or it runs out of contributed content.

When selecting messages or pictures, the tries to choose content from multiple Circle members. For this reason, the selection process shuffles the order of the list Circle members when selecting content. The following description summarizes a relevancy determination algorithm in which the system attempts to find twelve (12) content units for each booklet, and in which the system selects messages and photographs in groups of four (4).

look into text-messages pool

shuffle the order of the Circle Members list
pick one message per Circle Member for the Current Cycle
pool (FIFO -- First In First Out, picking by submission date,
oldest first).
If they don't have a message in the current cycle, pick from the
backlog (LIFO -- Last In First Out (picking by submission date,
newest first)
only pick up to four (4) messages

Then look into the pictures submitted for the current print cycle
(current issue)

shuffle the order of the Circle Members list
pick one picture per Circle Member for the Current Cycle pool
(FIFO).
If they don't have a picture in the current cycle, pick from the
backlog (UFO)

If don't have twelve (12) content units:

look into pictures submitted by Subscriber

pick up to 3 pictures from “Subscriber Current Cycle”
(FIFO)

If there are no pictures in the current cycle, pick
from backlog (UFO)

If don't have twelve (12) content units

go back to the beginning of rules set
If there is no more content (Pictures/Messages)

Pick “Filler content/Puzzles” until get twelve (12)
content units.

pick one filler content from each “filler content
bucket”.
Each filler content bucket has one kind of
puzzle.
One bucket has messages for “get your family
to share more pictures”

The following is a more detailed description of the relevancy rules:

Step 0 start with Content Units with a value of zero
Step 1 Messages from circle members

Maximum pick four (4) messages
shuffle the order of the Circle Members list
For every person in the “Circle Members”
Look for content in the “Messages Current
Cycle Bucket”

If there is content:

Grab one from there (FIFO)

If there is not content

Flag “Messages Current
Cycle Bucket” as EMPTY
Check in the Backlog bucket

If there is content pick one (LIFO)
If there is no content in backlog:

Flag “Messages Backlog” as
EMPTY

For every message pick

increase the value of “Content Units” by 1
stop picking messages after four (4)

Step 2 Pictures from circle members

shuffle the order of the Circle Members list
Look for content in the “Pictures Current Cycle Bucket”
If there is content:

Grab one from there (FIFO)

If there is not content

Flag “Pictures Current Cycle Bucket” as EMPTY
Check in the “Pictures Backlog” bucket

If there is content pick one (LIFO)
If there is no content in backlog

Flag Photo “Pictures Backlog” as EMPTY

For every picture pick

increase the value of “Content Units” by 1
Stop picking content if Content Units is twelve (12)

IF “Content Units” = twelve (12): STOP, SEND TO PRINTER
Step 3 Pick pictures from Current Subscriber (up to 3)

Look for content in Current Subscriber's “Pictures Current
Cycle Bucket”

If there is content:

Grab up to 3 from there (FIFO)

If there is not content

If “Pictures Backlog” is not EMPTY
Check in the Current Subscriber's “Pictures
Backlog” bucket

If there is content pick one (LIFO)

For every picture pick

increase the value of “Content Units” by 1
Stop picking content if Content Units is twelve
(12)

IF “Content Units” = twelve (12): STOP, SEND TO PRINTER
Else IF “Pictures Current Cycle Bucket” is EMPTY AND “Pictures
Backlog” is EMPTY AND “Messages Backlog” is EMPTY

For every Filler Content bucket

Pick one filler content
Every Filler Content pick: Increase the value of
“Content Units” by 1
When “Content Units” = twelve (12): STOP, SEND TO
PRINTER

Else:

Got back to Step 1

The following table provides exemplary pseudo-code for the relevancy selection algorithm:

PSEUDO-CODE

```
While ContentUnits < twelve (12) (once we get twelve (12), we stop
the cycle and send materials to printer)
        MessagesToPick = four (4)
        For every CircleMember
              shuffle the list of CircleMembers
              If they have content in “Current Cycle Messages Bucket”
AND MessagesToPick > 0
              Pick a message (FIFO)
              MessagesToPick = MessagesToPick − 1
              ContentUnits = ContentUnits + 1
        Else mark “Current Cycle Messages Bucket” as EMPTY
        If they have content in “Backlog Messages Bucket” AND
MessagesToPick > 0
              Pick a message (LIFO)
              MessagesToPick = MessagesToPick − 1
              ContentUnits = ContentUnits + 1
              Else mark “Backlog Messages Bucket” as EMPTY
              If ContentUnits = twelve (12): STOP AND SEND TO
PRINTER (We will never hit this on the 1st pass)
        For every CircleMember
              shuffle the list of CircleMembers
              If they have content in “Current Cycle Pictures Bucket”
                    Pick a picture (FIFO)
                    ContentUnits = ContentUnits + 1
              Else mark “Current Cycle Pictures Bucket” as EMPTY
              If they have content in “Backlog Pictures Bucket”
                    Pick a picture (LIFO)
                    ContentUnits = ContentUnits + 1
              Else mark “Backlog Pictures Bucket” as EMPTY
              If ContentUnits = twelve (12): STOP AND SEND TO
PRINTER
        Subscriber's bucket size = 3
        While “ Subscriber's bucket size” is > 0
        If Subscriber's “Current Cycle Pictures Bucket” is not empty
              Pick a picture (FIFO)
              ContentUnits = ContentUnits + 1
              Granma's bucket size − 1
        Else if Subscriber's “Backlog Pictures Bucket” is not empty
              Pick a picture (LIFO)
              ContentUnits = ContentUnits + 1
              Subscriber's bucket size − 1
        Else
              This means we don't have more pictures to pick from
              Break out of“ Subscriber's While” loop
        If ContentUnits = twelve (12): STOP AND SEND TO
        PRINTER
If  “Current Cycle Pictures Bucket”
        AND “Backlog Pictures Bucket”
        AND “Current Cycle Messages Bucket” AND “Backlog
Messages Bucket”
        Are all marked as EMPTY
        While ContentUnits < twelve (12)
              For each Filler Content bucket
              Pick one content
              ContentUnits + 1
```

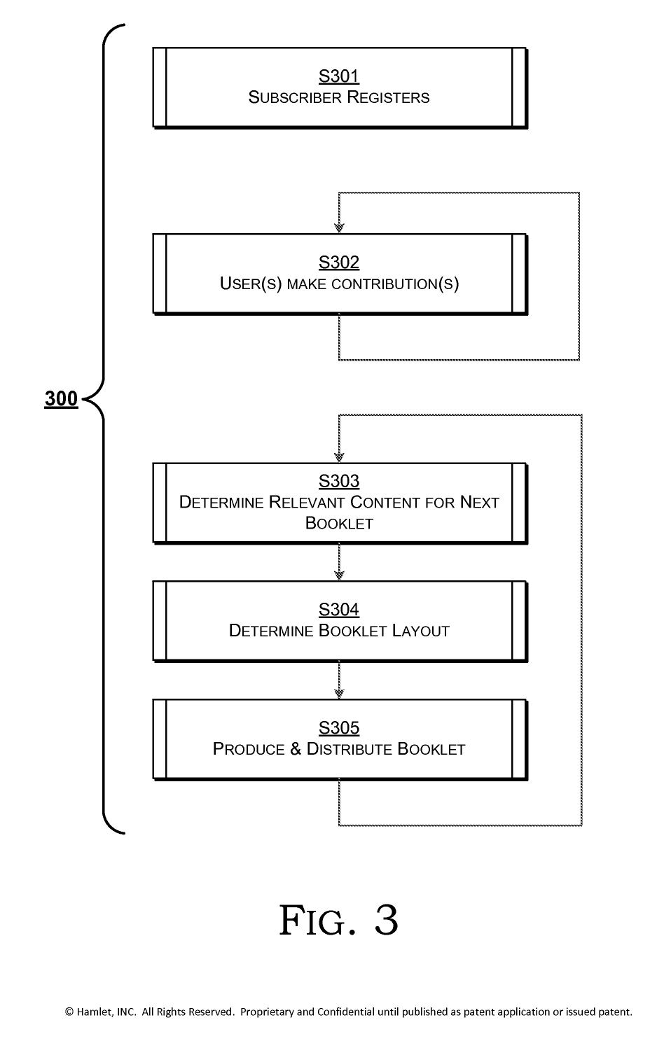

FIG. 4 is a flowchart depicting the above relevancy selection algorithm, implemented, for example, using relevancy applications 136.

Determining Content Layout

Having selected the appropriate number of content units, the system may proceed to perform the booklet layout. As will be appreciated, and as has been noted, the selection of relevant content units is separate and distinct from the content layout. These 2 phases may take place at different times. The content layout determination needs only to obtain the sufficient number of relevant content units, without having to know when or how those were determined.

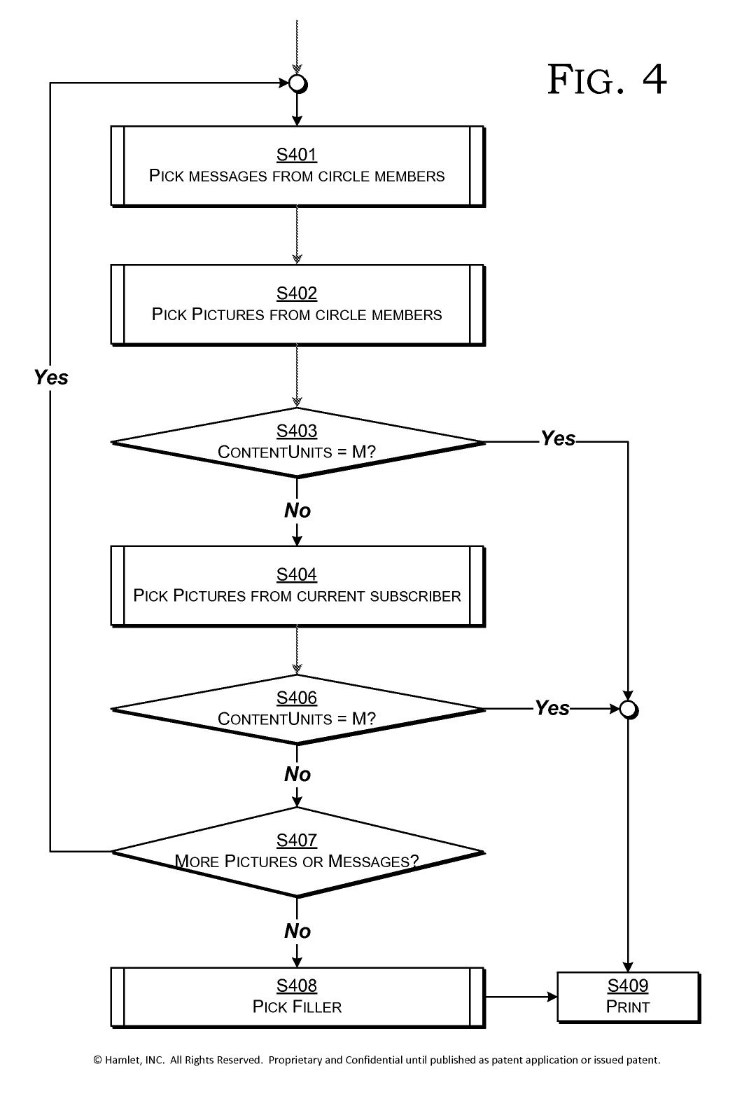

FIGS. 5A and 5B show two exemplary booklet layouts, each referred to herein as a template. The template shown in FIG. 5A is for a four panel booklet (referred to herein as Template A), whereas the template shown in FIG. 5B is for a six panel template (referred to herein as Template B). As noted above, the system is not limited in any way by the example templates shown here, and different and/or other templates may be used.

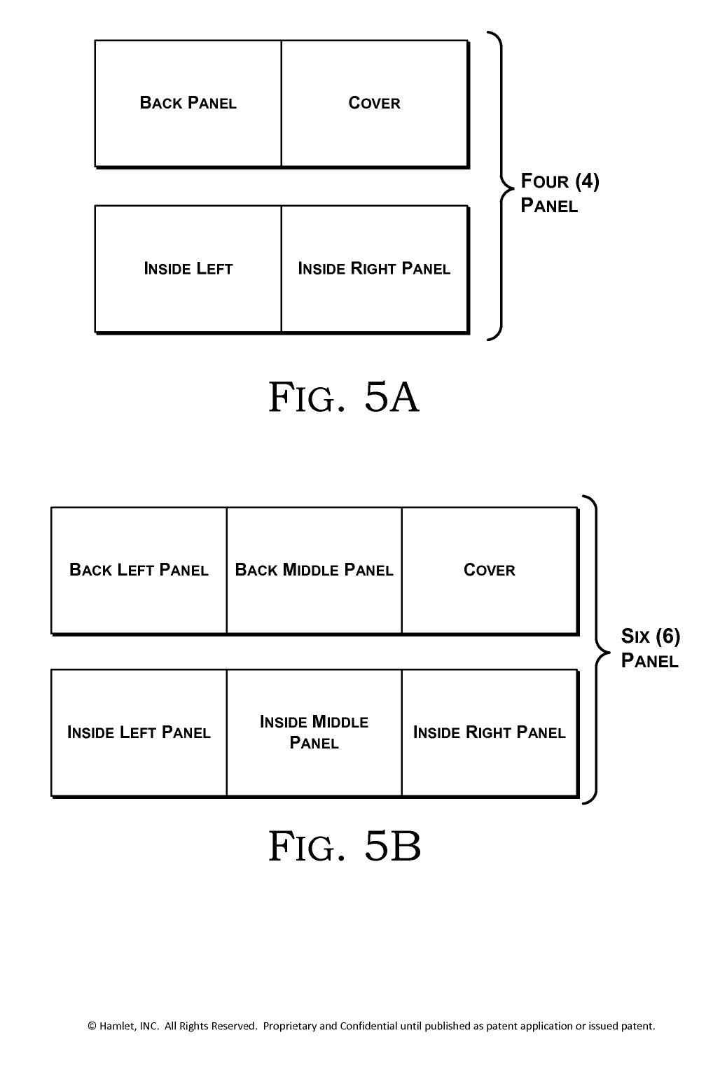

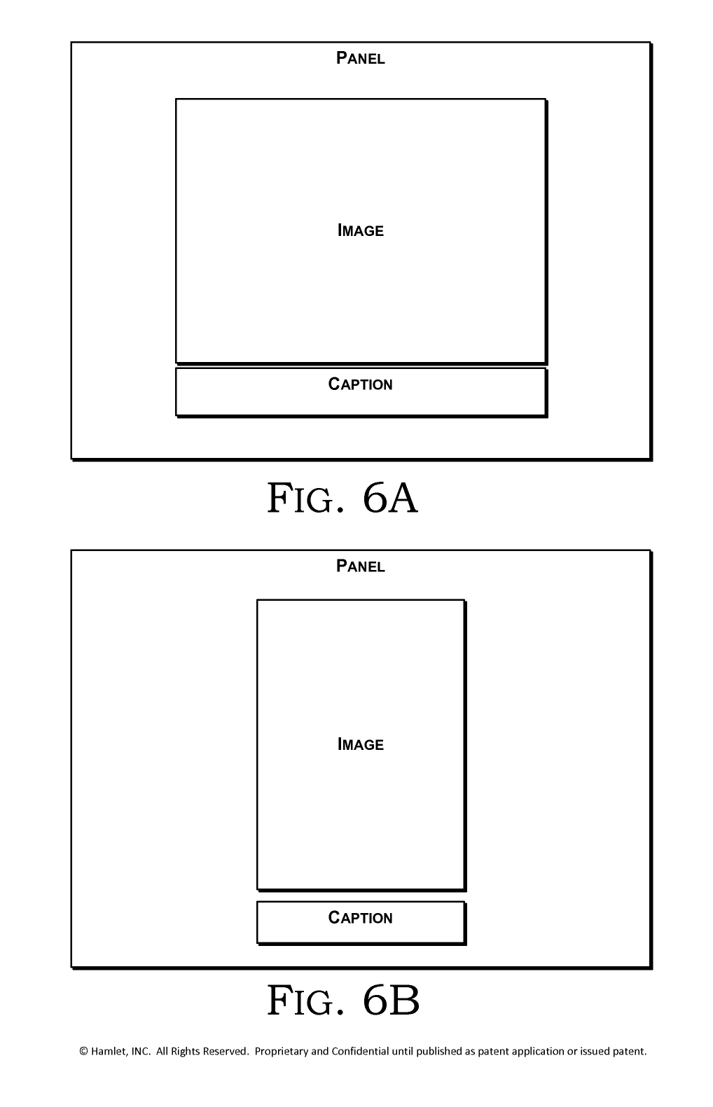

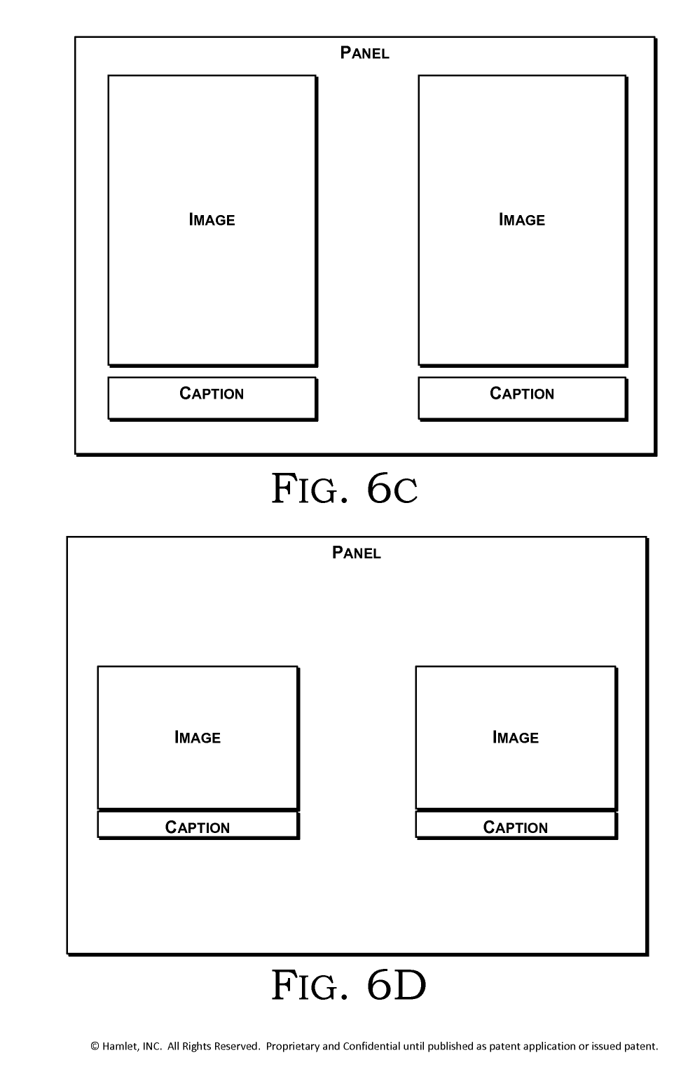

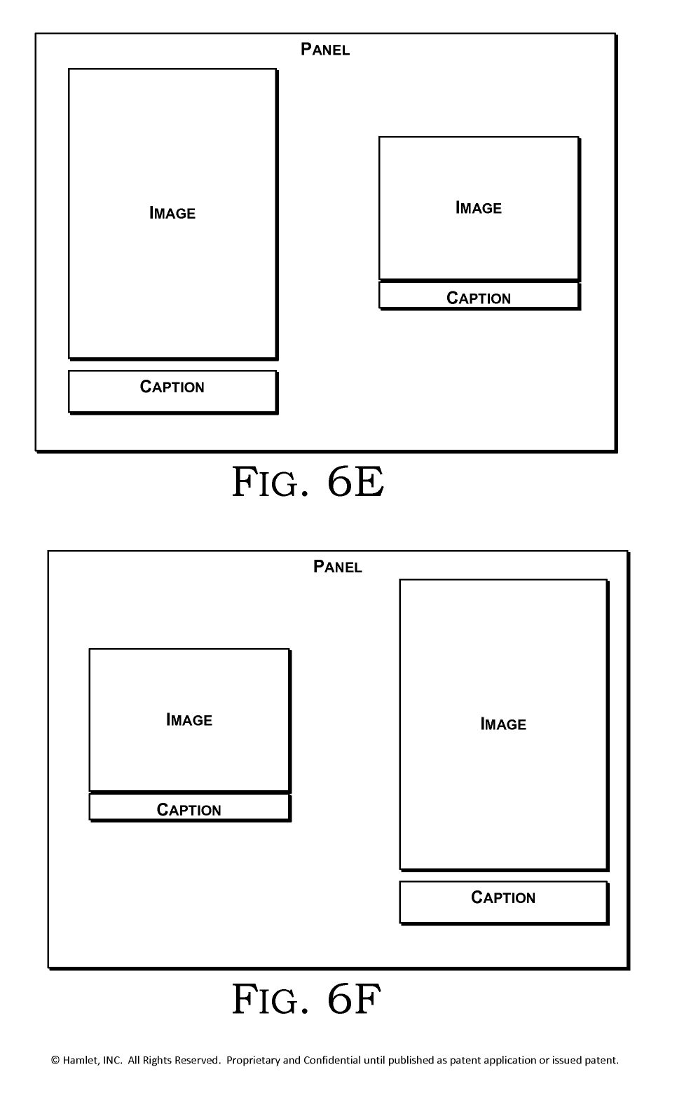

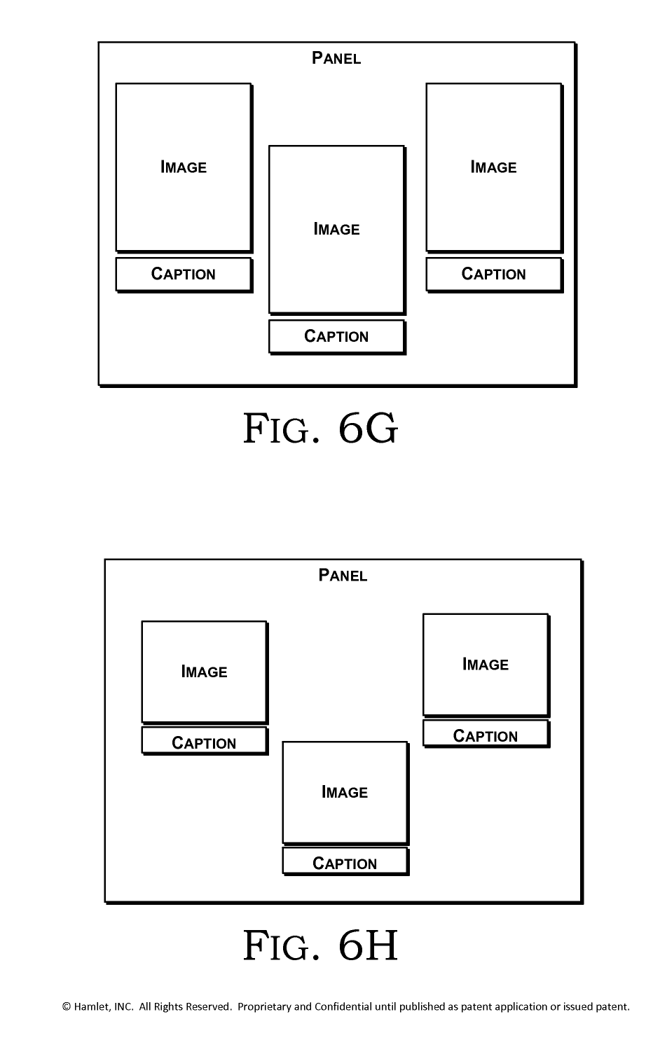

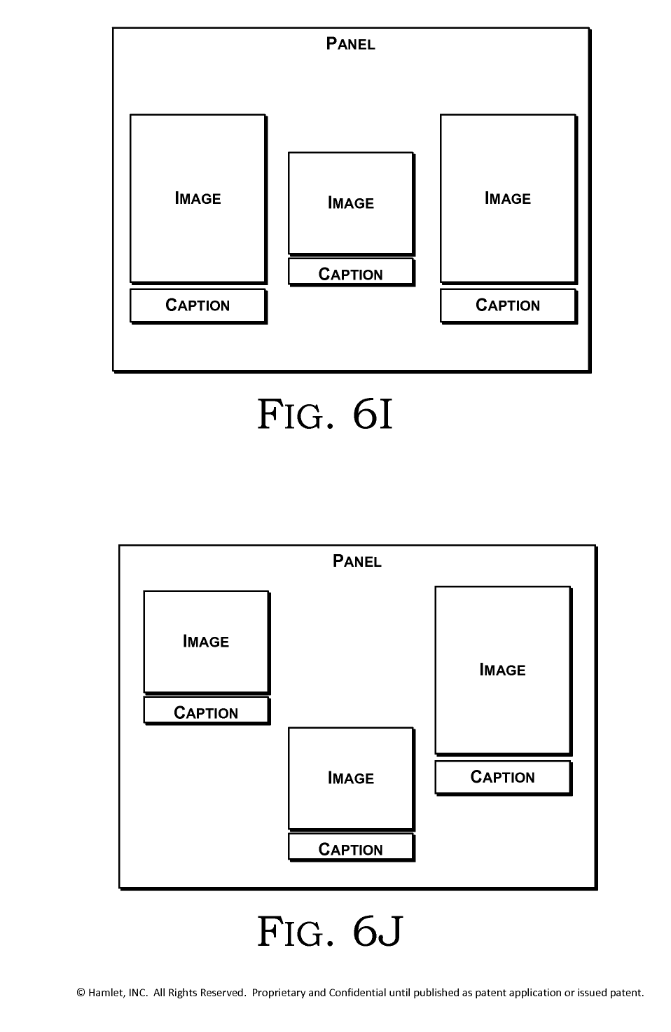

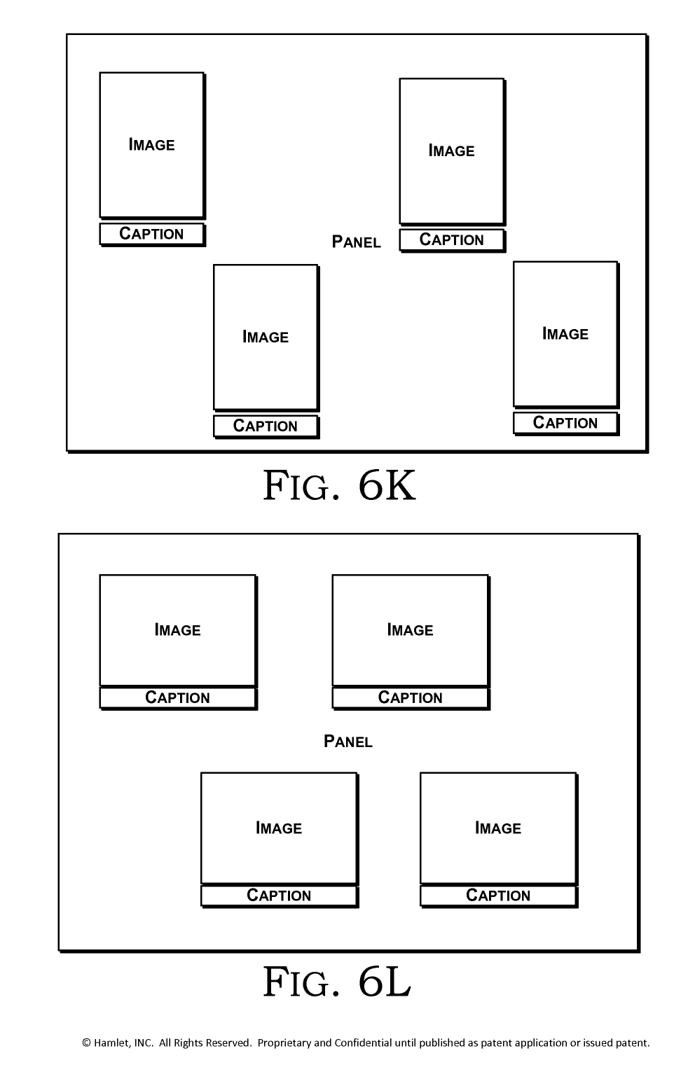

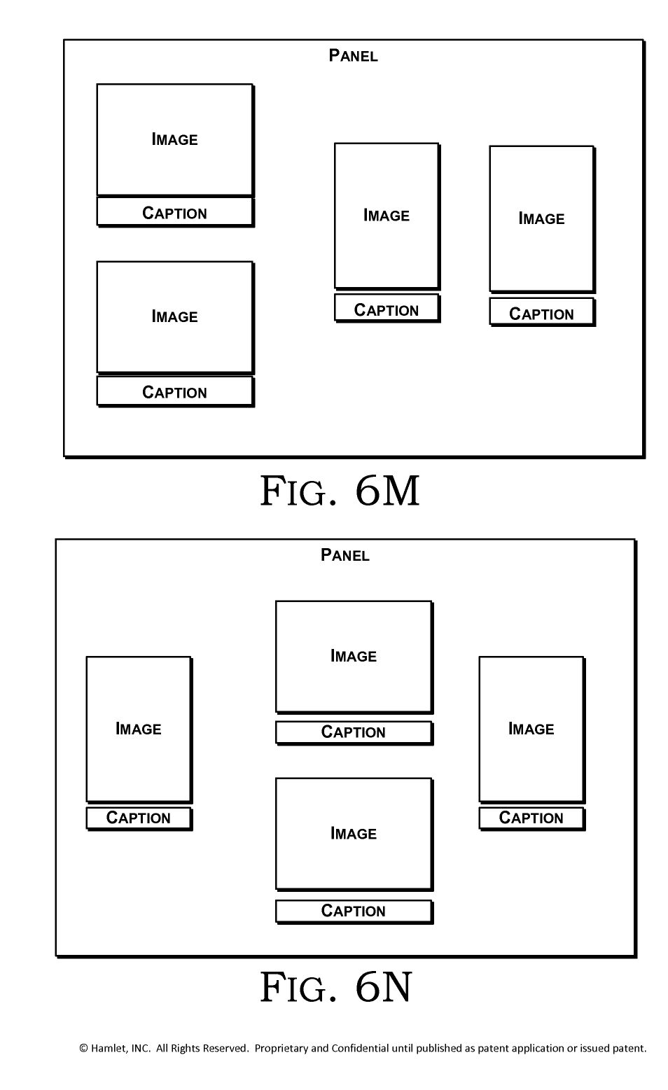

As can be seen in the drawings, each template consists of a number of panels. Each template panel has a panel layout, preferably selected from a collection of possible panel layouts. FIGS. 6A-6N show fourteen (14) exemplary panel layouts for images (image content) and associated captions. Each panel in a template may be laid out according to one of these panel layouts. It should be appreciated that the panel layouts shown in these drawings are merely examples and are not intended to limit the system in any way, and different and/or other panel layouts may be used.

The following describes an exemplary algorithm for template and panel selection and layout, and for determining panel priority for content. It is assumed that at this time (in this second phase) the entity doing the content layout accesses the relevant content determined in the previous phase. If the entity performing the content layout is at a different location (e.g., it is a separate printing entity) then it may obtain the relevant content from the backend servers in some known and secure manner. It may also be assumed that the entity determining the content layout is provided with all content needed to populate a booklet. In some instances, however, the printing entity may include filler content that it determines itself. For example, if the first phase determines that a particular content item will be filler content such as a crossword puzzle, the printing entity may either be provided with an image comprising that crossword puzzle or it may provide its own crossword puzzle as that filler.

The printing entity (that determines the layout and produces the actual booklet) is preferably also provided with the intended recipient's (subscriber's) name and mailing address.

In some cases the template may require artwork separate from the content units. Preferably the printer is provided with all necessary artwork, fonts, color specifications, and any other items needed to produce a booklet.

The following is an exemplary algorithm for content layout.

| 1. | One full panel reserved for messages | |
|---|---|---|
| | a. | if one message is available, there is a message panel |

| | |
|---|---|
| i. | Use the “last” panel: defined as the “outside back” |
| | depending on what form factor/template is used |

| | b. | If number of messages exceed room available on one |
|---|---|---|
| | | panel, consider number of images - possible to have |
| | | multiple message panels |
| | c. | If only messages and no photos available, distribute |
| | | messages between panels, and potentially add “filler” |
| | | content as needed (see below) |
| 2. | As many photos as possible, up to the maximum number | |
| | a. | Max images per panel = four (4) images |
| 3. | Fill remaining panels with messages | |
| | a. | Balance the messages between message panels if |
| | | needed |
| | b. | have header for contributors that say “From |
| | | [ContributorName]” with dotted line artwork below |
| | c. | Messages should scale between smallest font size |
| | | (twelve (12) pt) and largest font size (22 pt) |
| 4. | Fill remaining panels with syndicated content (supplied by | |
| | backend) | |
| | a. | Syndicated content will only be applied when full panels |
| | | are remaining |

| | |
|---|---|
| i. | Possible to have more than one panel of |
| | syndicated content if needed |

| | |
|---|---|
| b. | Syndicated content will be stored on backend servers as |
| | an image |

| | |
|---|---|
| i. | Sudoku puzzles |
| ii. | Word Jumbles |
| iii. | Word Search puzzles |

Those of ordinary skill in the art will realize and understand, upon reading this description, that different and/or other layout algorithms may be used. In addition, values that are selected for the algorithm, e.g., the maximum number of images and the smallest and largest font sizes, may vary.

The printer preferably implements various message placement and image placement rules. The following are exemplary message and image placement rules from a preferred implementation. As will be appreciated, different message and image placement rules may be used.

Exemplary Message Placement Rules (Implemented by Printer)
1. Messages are always placed in date-submitted order, regardless of contributor
2. Display messages with date/time stamp and identify user
   a. “From [ContributorName]” with dotted line artwork below, then message below that
3. If message character count is low, increase font size up to 22 point
4. If content character count is high, decrease font size down to twelve (12) point

Exemplary Image Placement Rules (Implemented by Printer)

Assume images will be 240 ppi or higher; if quality is not good enough, adjust our rules on upload as needed. Assume images will not have been color managed
1. Group images by contributor, in date taken order
2. Sort groups by date of first submitted image
3. Sort constraint: linear ordering from (2); Mix groups across panels minimally
   a. When a user submits more than one photo, group those photos together; If more than one panel full of photos for one contributor, ok to split group of photos onto two panels; ok to have more than one group on a panel, but should try to keep the photos grouped together by contributor
4. Display images in relevancy sequence order as received from backend (relevancy algorithm) as listed below
   a. Image 1=If one image, show centered; if two or more images show on left, or top left
   b. Image 2=If two images, show on right or top right
   c. Image 3=If three images, show on bottom centered
   d. Image four (4)=If four images, show on bottom right
   e. NOTE: Will adjust if we allow more than four (4) images on a panel
5. Display images in orientation received (landscape, horizontal, square, other)
   a. Take the orientation received and fit accordingly; i.e., scale to fit and center in consistent image container.
6. Display images with associated captions
   a. backend to indicate which captions go with which images in content transmission
   b. For captions: 2 font size and leading options for photo captions depending on length of caption and # of images (10.5/twelve (12) and twelve (12)113.5)
7. Display images with contributor/user information
   a. Backend to indicate which contributor/user is associated with which images
   b. Formatting Rules:
      i. With Caption: [Caption]—from [ContributorFirstName]
      ii. Without Caption: Photo shared by [ContributorFirstName]

Booklet Distribution

Once the booklets have been produced they may be mailed or otherwise distributed. In addition, preferably a version of each booklet (e.g., in PDF format) is available via a web interface, so that subscribers and other users may view the booklets.

### Examples

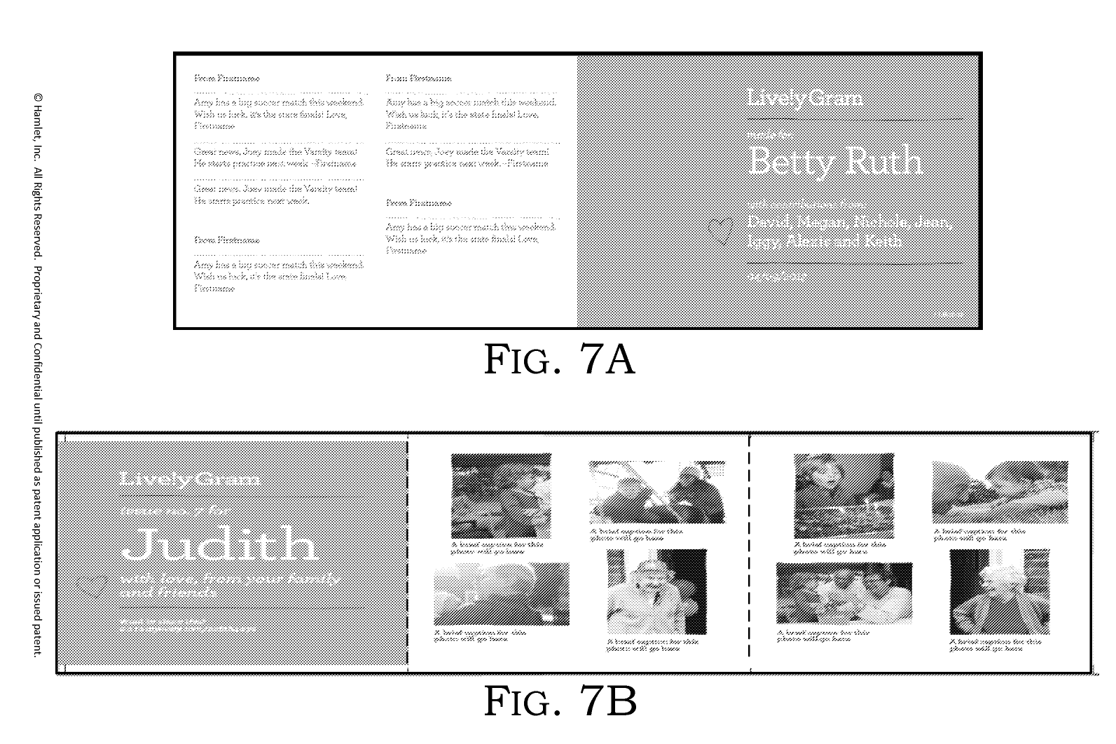

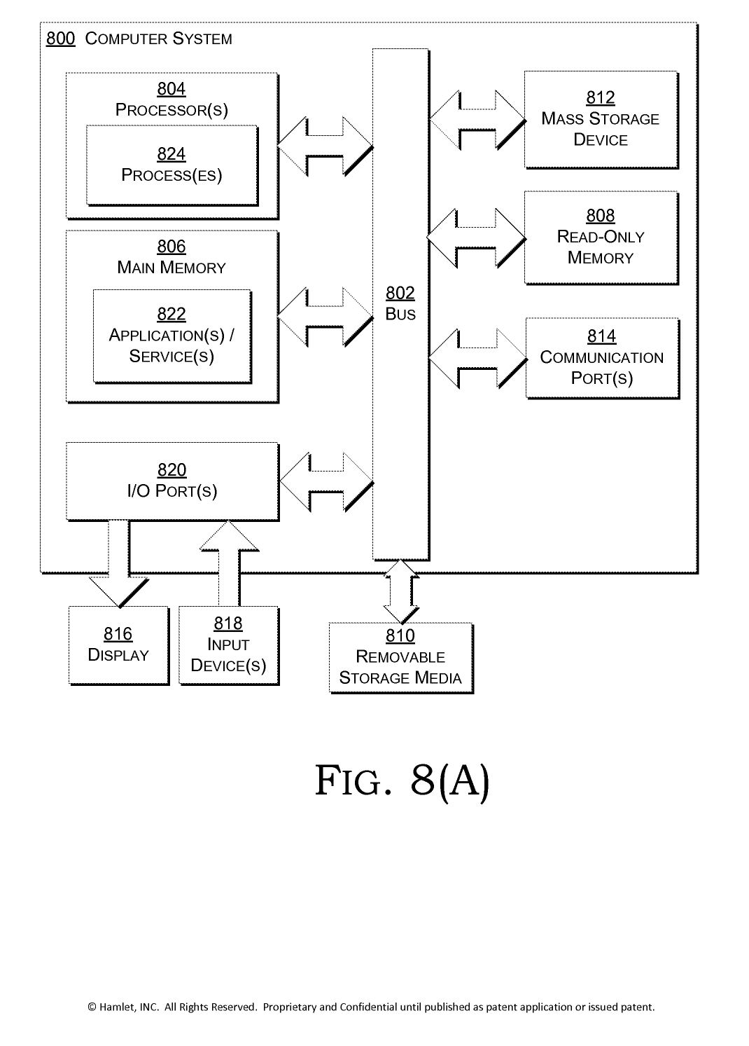

FIGS. 7A and 7B shown example booklets produced in accordance with the system 100.

### Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

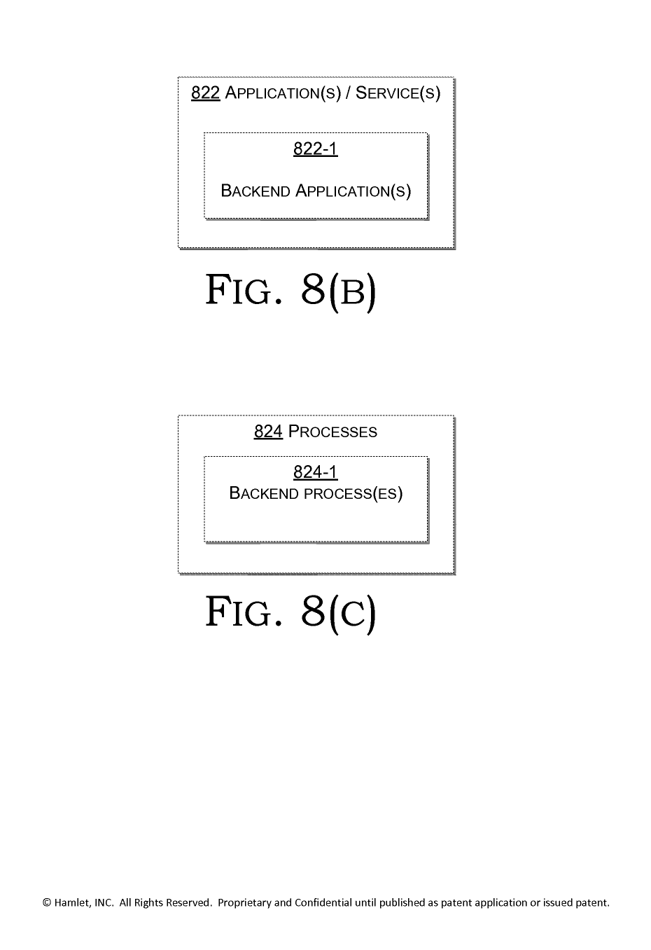

FIG. 8A is a schematic diagram of a computer system 800 upon which embodiments of the present disclosure may be implemented and carried out.

According to the present example, the computer system 800 includes a bus 802 (i.e., interconnect), one or more processors 804, one or more communications ports 814, a main memory 806, removable storage media 810, read-only memory 808, and a mass storage 812. Communication port(s) 814 may be connected to one or more networks by way of which the computer system 800 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 804 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 814 can be any of an RS-232 port for use with a modem based dial-up connection, a 10/100 Ethernet port, a Gigabit port using copper or fiber, or a USB port, and the like. Communications port(s) 814 may be chosen depending on a network such as a Local Area Network (LAN), a Wide Area Network (WAN), a content delivery network (CDN), or any network to which the computer system 800 connects. The computer system 800 may be in communication with peripheral devices (e.g., display screen 816, input device(s) 818) via Input/Output (I/O) port 820. Some or all of the peripheral devices may be integrated into the computer system 800, and the input device(s) 818 may be integrated into the display screen 816 (e.g., in the case of a touch screen).

Main memory 806 can be Random Access Memory (RAM), or any other dynamic storage device(s) commonly known in the art. Read-only memory 808 can be any static storage device(s) such as Programmable Read-Only Memory (PROM) chips for storing static information such as instructions for processor(s) 804. Mass storage 812 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 802 communicatively couples processor(s) 804 with the other memory, storage and communications blocks. Bus 802 can be a PCI/PCI-X, SCSI, a Universal Serial Bus (USB) based system bus (or other) depending on the storage devices used, and the like. Removable storage media 810 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 806 is encoded with application(s) 822 that support(s) the functionality as discussed herein (an application 822 may be an application that provides some or all of the functionality of one or more of the mechanisms described herein). Application(s) 822 (and/or other resources as described herein) can be embodied as software code such as data and/or logic instructions (e.g., code stored in the memory or on another computer readable medium such as a disk) that supports processing functionality according to different embodiments described herein.

For example, as shown in FIGS. 8B and 8C, respectively, application(s) 822 may include backend application(s) 822-1 (corresponding to 114 in FIG. 1), and processes 824 may include backend process(es) 824-1 corresponding to one or more of the backend application(s) 822-1.

During operation of one embodiment, processor(s) 804 accesses main memory 806 via the use of bus 802 in order to launch, run, execute, interpret or otherwise perform the logic instructions of the application(s) 822. Execution of application(s) 822 produces processing functionality of the service(s) or mechanism(s) related to the application(s). In other words, the process(es) 824 represents one or more portions of the application(s) 822 performing within or upon the processor(s) 804 in the computer system 800.

It should be noted that, in addition to the process(es) 824 that carries(carry) out operations as discussed herein, other embodiments herein include the application 822 itself (i.e., the un-executed or non-performing logic instructions and/or data). The application 822 may be stored on a computer readable medium (e.g., a repository) such as a disk or in an optical medium. According to other embodiments, the application 822 can also be stored in a memory type system such as in firmware, read only memory (ROM), or, as in this example, as executable code within the main memory 806 (e.g., within Random Access Memory or RAM). For example, application 822 may also be stored in removable storage media 810, read-only memory 808, and/or mass storage device 812.

Those skilled in the art will understand that the computer system 800 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention.

In another embodiment, the process includes some human intervention (e.g., a step is performed by or with the assistance of a human).

As used in this description, the term “portion” means some or all. So, for example, “A portion of X” may include some of “X” or all of “X”. In the context of a conversation, the term “portion” means some or all of the conversation.

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

As used herein, including in the claims, a list may include only one item, and, unless otherwise stated, a list of multiple items need not be ordered in any particular manner. A list may include duplicate items. For example, as used herein, the phrase “a list of XYZs” may include one or more “XYZs”.

It should be appreciated that the words “first” and “second” in the description and claims are used to distinguish or identify, and not to show a serial or numerical limitation. Similarly, the use of letter or numerical labels (such as “(a)”, “(b)”, and the like) are used to help distinguish and/or identify, and not to show any serial or numerical limitation or ordering. No ordering is implied by any of the labeled boxes in any of the flow diagrams unless specifically shown and stated. When disconnected boxes are shown in a diagram the activities associated with those boxes may be performed in any order, including fully or partially in parallel.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

We claim:

1. A computer-implemented method comprising:
(A) associating at least one user with a subscriber to a system;
(B) obtaining and storing at least one content contribution from said at least one user;
(C) determining relevant content from said at least one content contribution;
(D) determining a booklet layout for said relevant content; and
(E) producing said booklet with said relevant content based on booklet layout.

2. The method of claim 1 wherein said content contribution is selected from: message content and image content.

3. The method of claim 1 wherein said relevant content includes at least one message content contribution.

4. The method of claim 1 wherein said relevant content comprises:
message content, image content, and filler content.

5. The method of claim 4 wherein the relevant content comprises filler content when there is insufficient message content and image content.

6. The method of claim 1 wherein a plurality of users are associated with said subscriber, and wherein said relevant content comprises contributed content from more than one user associated with the subscriber.

7. The method of claim 1 further comprising:
(F) sending the booklet to the subscriber.

8. The method of claim 1 wherein step (B) is repeated.

9. The method of claim 1 wherein steps (C) to (E) are repeated at regular intervals.

10. The method of claim 9 wherein steps (C) to (E) are repeated every two weeks.

11. The method of claim 1 wherein the step (C) of determining relevant content determines relevant content based on predefined relevancy rules.

12. The method of claim 1 wherein the step (D) of determining booklet layout determines relevant content based on predefined layout rules.

13. A device comprising hardware, including a processor and a memory, the device being programmed to:
(A) associate at least one user with a subscriber to a system;
(B) obtain and storing at least one content contribution from said at least one user;
(C) determine relevant content from said at least one content contribution;
(D) determine a booklet layout for said relevant content; and
(E) produce said booklet with said relevant content based on booklet layout.

14. The device of claim 13 wherein said content contribution is selected from: message content and image content.

15. The device of claim 13 wherein said relevant content includes at least one message content contribution.

16. A tangible non-transitory computer-readable storage medium comprising instructions for execution on a device, wherein the instructions, when executed, perform acts of the method comprising:
(A) associating at least one user with a subscriber to a system;
(B) obtaining and storing at least one content contribution from said at least one user;
(C) determining relevant content from said at least one content contribution;
(D) determining a booklet layout for said relevant content; and
(E) producing said booklet with said relevant content based on booklet layout.

17. A computer-implemented system constructed and adapted to:
(A) associate at least one user with a subscriber to the system;
(B) obtain and store at least one content contribution from said at least one user;
(C) determine relevant content from said at least one content contribution;
(D) determine a booklet layout for said relevant content; and
(E) produce said booklet with said relevant content based on booklet layout.

18. The system of claim 17 wherein said relevant content comprises: message content, image content, and filler content.

19. The system of claim 18 wherein the relevant content comprises filler content when there is insufficient message content and image content.

20. The system of claim 17 wherein a plurality of users are associated with said subscriber, and wherein said relevant content comprises contributed content from more than one user associated with the subscriber.
